(19) United States
(12) Patent Application Publication
(10) Pub. No.: US 2009/0167943 A1
(43) Pub. Date: Jul. 2, 2009

(54) Apparatus and Method for Synchronizing Video and Audio Data

(75) Inventors: Xiaoyu Gao, Beijing (CN); Fen Zhou, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/965,728

(22) Filed: Dec. 27, 2007

(51) Int. Cl. H04N 9/475

(52) U.S. Cl. 348/515; 348/E09.034

(57) ABSTRACT

Techniques for synchronizing audio and video data being transferred from one device to another device are disclosed. According to one aspect of the present invention, a periodic signal is generated in a host device (e.g., a personal computer) and transferred to a thin device (e.g., a PC camera) via an interface (e.g., a USB). The periodic signal is used to adjust local clocks in the thin device to generate audio and video data. As a result, the audio and video data is synchronized. According to another aspect of the present invention, an error detection unit and a correction unit are provided to ensure that there is no error in the periodic signal being transferred from the host device. If an error is detected, a patch to the signal is generated.

### BACKGROUND OF THE INVENTION

1. Field of the Invention

The present invention relates to the area of video and audio signal processing, and more particularly to an apparatus and a method for synchronizing video and audio data.

2. Description of Related Art

It is an important problem to synchronize a video signal with an audio signal, provided that the video and audio signals are part of a media file. The video signal and the audio signal may have went through various processing, such as sampling, transferring, encoding, decoding.

Referring to FIG. 1, which is a schematic block diagram showing a conventional USB (Universal Serial Bus) transfer system including a USB host controller 120 (e.g. a personal computer or PC) and a USB-based device 110 (e.g., a PC camera). The device 110 is connected with the USB host controller 120 via an USB interface, the device 110 may be provided to record audio and video data at the same time and transfer the data to the host controller 120. The USB host controller 120 is provided to receive the audio and video data and play back them by a host clock thereof.

The device 110 includes an audio clock generator 111, an audio sampling unit 112, a video clock generator 113 and a video sampling unit 114. The audio clock generator 111 generates a local audio clock for the audio sampling unit 112, the audio sampling unit 112 samples audio data at a predetermined sampling-rate by the local audio clock and transfers the audio data to the USB host controller 120 via the USB interface. At the same time, the video clock generator 113 generates a local video clock for the video sampling unit 114, the video sampling unit 114 acquires video data at a predetermined frame-rate by the local video clock and transfers the video data to the host controller 120 via the USB interface.

However, as shown in FIG. 1, since the local audio clock is independent from the local video clock and a random error may occur between the local audio clock and the local video clock, the video data may become out of sync with the audio data even if the video and audio data is recorded at the same time. With the random error accumulated, the synchronicity between the video data and the audio data may become worse.

Furthermore, the host clock by which the host controller 120 plays back the video and audio data may also be out of synchronization with the local video and audio clock in the device 110. Likewise, a random error may also occur between the host clock and the local clocks, which may further adversely influence the synchronicity between the video and audio data.

Thus, there is a need for techniques for synchronizing the video data and the audio data in a transfer system.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to techniques for synchronizing audio and video data being transferred from one device to another device. According to one aspect of the present invention, a periodic signal is generated in a host device (e.g., a personal computer) and transferred to a thin device (e.g., a PC camera) via an interface (e.g., a USB). The periodic signal is used to adjust local clocks in the thin device to generate audio and video data. As a result, the audio and video data is synchronized.

According to another aspect of the present invention, an error detection unit and a correction unit are provided to ensure that there is no error in the periodic signal being transferred from the host device. If an error is detected, a patch to the signal is generated.

One of the features, benefits and advantages in the present invention is to provide techniques for synchronizing audio and video data.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a schematic view showing a conventional USB transfer system including a USB host controller and a USB-based device;

FIG. 2 is a schematic block diagram showing an apparatus for synchronizing video and audio data according to one embodiment of the present invention;

FIG. 3 is a flowchart or process for synchronizing video and audio data according to one embodiment of the present invention; and

FIG. 4 is a schematic block diagram for synchronizing video and audio data according to another embodiment of the present invention.

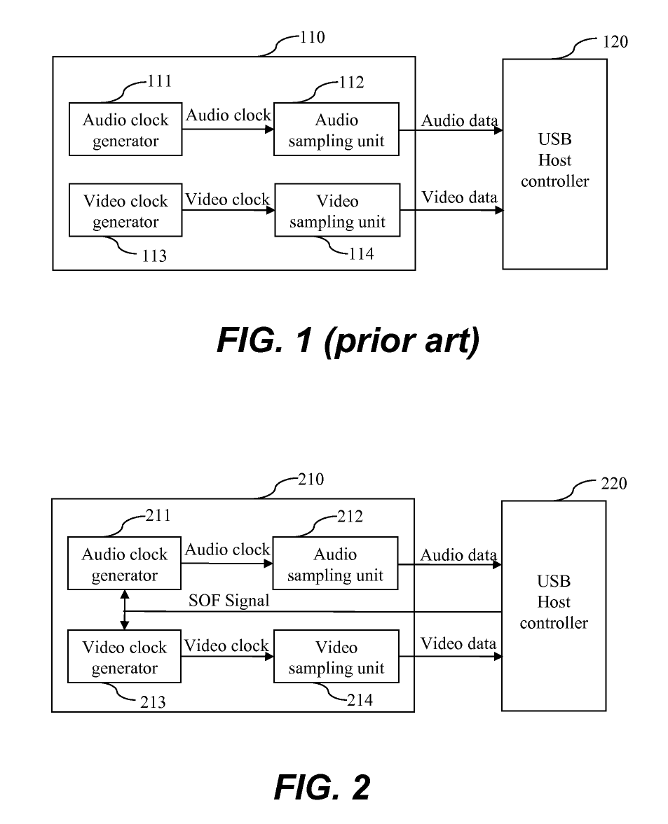

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

Embodiments of the present invention are discussed herein with reference to FIGS. 2-4. However, those skilled in the art will readily appreciate that the detailed description given herein with respect to these figures is for explanatory purposes only as the invention extends beyond these limited embodiments.

FIG. 2 is a schematic block diagram for synchronizing video and audio data according to one embodiment of the present invention. As shown in FIG. 2, the apparatus comprises a computing device including a USB interface, which is shown as a host controller 220, and a USB device 210 (e.g., a PC camera). The device 210 is connected with the host controller 220 via an USB interface (not shown). The USB device 210 is provided to record audio and video signals at the same time and transfer corresponding audio and video data to the host controller 120. The host controller 120 is provided to receive the audio and video data and play back the recorded audio and video data by a host clock thereof.

The device 210 includes an audio clock generator 211, an audio sampling unit 212, a video clock generator 213 and a video sampling unit 214. The audio clock generator 211 generates a local audio clock for the audio sampling unit 212, the audio sampling unit 212 samples the audio signals by the local audio clock and transfers the audio data to the host controller 220 via the USB interface. At the same time, the video clock generator 213 generates a local video clock for the video sampling unit 214, the video sampling unit 214 acquires corresponding video data by the local video clock and transfers the video data to the host controller 220 via the USB interface.

As shown in FIG. 2, one of the important features, objects and benefits in the present invention is that the host controller 120 generates a periodical start of a frame (SOF) signal by the host clock and sends the signal to the audio and video clock generators 211 and 213. In a particular implementation, the frequency of SOF may be 8 KHz when data transfers via the USB interface between the USB device and the host controller in a high speed mode and may be 1 KHz in a full speed mode. In one embodiment, the host controller 220 comprises a signal generator for generating the periodical SOF signal.

After receiving each SOF signal, the audio clock generator 211 adjusts its output local audio clock according to the SOF signal, and the video clock generator 213 adjusts its output local video clock according to the SOF signal. As a result, the local audio and video clocks are synchronized with the host clock in the host controller since the SOF signal is generated from the host controller 220 and exactly synchronized with the host clock.

As a result, the local audio and video clocks are indirectly synchronized with each other. The primary factor which influences the synchronicity of the audio and video data is eliminated. The host controller 220 can be configured to play back the audio and video data synchronously as long as the USB device 210 records the audio and video signals at the same time.

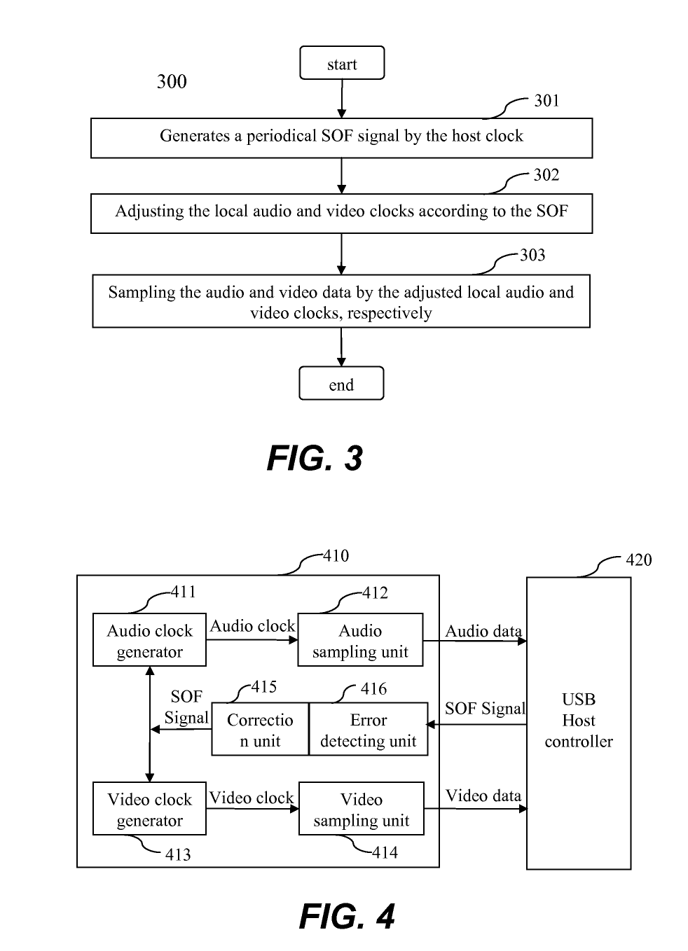

In order to further understand the present invention, FIG. 3 shows a flowchart or process 300 for synchronizing video and audio data according to one embodiment of the present invention. The process 300 may be understood in conjunction with FIG. 2.

At 301, a host device or controller 220 generates a periodical SOF signal (e.g., from its own host clock) and sends the SOF signal to the video clock generator 213 and the audio clock generator 211.

At 302, the audio clock generator 211 adjusts the local audio clock according to the SOF signal and outputs an adjusted local audio clock to the audio sampling unit 212; at the same time, the video clock generator 213 adjusts the local video clock according to the SOF signal and outputs the adjusted local video clock to the video sampling unit 214.

At 303, the audio sampling unit 212 samples an audio signal by the adjusted local audio clock and transfers the audio data to the host controller 220 via the USB interface. At the same time, the video sampling unit 214 acquires video data by the adjusted local video clock and transfers the data to the host controller 220 via the USB interface.

With the received audio and video data, the host controller 220 can play back the audio and video data synchronously as long as the USB device 210 records the audio and video data at the same time.

According to one embodiment, the SOF signal must be reliably transferred in order to ensure the synchronization of the host clock and the local clocks. If the SOF signal fails to be transferred, the synchronization of the host clock and the local clocks may be adversely influenced. Hence, an improved apparatus is provided hereafter for resolving the above problem according to an embodiment of the present invention.

Referring now to FIG. 4, which shows an improved apparatus according to the preferred embodiment of the present invention, an error detecting unit 416 and a correction unit 415 is added into the USB device 410. The error detecting unit 416 is provided for determining if the SOF signal from the host controller is lost. If yes, the error detecting unit 416 informs the correction unit 415 of patching one SOF signal immediately to the audio and video clock generator 411 and 413, otherwise, the error detecting unit 416 and the correction unit 415 do nothing on the SOF signal so that the SOF signal is directly transferred to the audio and video clock generator 411 and 413. It should be noted that the error detecting unit 416 and the correction unit 415 can also be implemented as one integrated unit in another embodiment.

The process of the improved apparatus shown in FIG. 4 is considerably similar to that of FIG. 3 except for the process 301. Namely, the process 301 may be improved by the following processes. first, the host controller 420 generates a periodical SOF signal by its own host clock and sends the signal to the error detecting unit 415. Next, the error detecting unit 416 is configured to determine if the SOF signal from the host controller is lost. If yes, the error detecting unit 416 informs the correction unit 415 of patching one SOF signal to the audio and video clock generator 411 and 413, otherwise, the error detecting unit 416 directly transfers the SOF signal to the audio and video clock generator 411 and 413.

In the above embodiment, the USB device 410 and the host controller 420 are taken as one example to describe the present invention. Actually, the USB host controller can be replaced by all type of controllers as long as it can accurately produce a periodical SOF signal by its own clock. Accordingly, the USB device can be replaced by all type of devices which can capture and transfer the audio and video data at the same time. Likewise, the SOF signal can also be replaced by a periodical signal as long as it can achieve the purpose of the SOF signal in the present invention.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. An apparatus for synchronizing video and audio data, the apparatus comprising:
a host controller provided for generating a periodical signal;
a device, coupled to the host controller via an interface, provided for adjusting a video clock and an audio clock therein according to the periodical signal received form the interface, the device configured to capture audio data by the adjusted audio clock and video data by the adjusted video clock, and transferring the audio data and video data to the host controller.

2. The apparatus according to claim 1, wherein the host controller comprises a signal generator for generating the periodical signal.

3. The apparatus according to claim 2, wherein the periodical signal is a start of frame signal.

4. The apparatus according to claim 1, wherein the device comprises:
an audio clock generator for generating the audio clock and adjusting the audio clock according to the periodical signal;
an audio sampling unit for capturing the audio data by the adjusted audio clock and transferring the audio data to the host controller;
a video clock generator for generating the video clock and adjusting the video clock according to the periodical signal; and
a video sampling unit for capturing the video data by the adjusted video clock and transferring the video data to the host controller.

5. The apparatus according to claim 4, wherein the device further comprises an error detecting unit and a correction unit, the error detecting unit is provided for determining if the periodical signal from the host controller is lost, if yes, the error detecting unit informs the correction unit of patching one periodical signal to the audio and video clock generator; otherwise, the error detecting unit directly forwards the periodical signal to the audio and video clock generator.

6. The apparatus according to claim 1, wherein the host controller is a USB host controller, the device is a USB device connecting with the USB host controller via the interface being a USB interface.

7. The apparatus according to claim 6, wherein the frequency of the periodical signal is 8 KHz when data transfers via the USB interface between the USB device and the USB host controller in a high speed mode, and is 1 KHz when data transfer via the USB interface between the USB device and the USB host controller in a full speed mode.

8. A method for synchronizing video and audio data in a transfer system, the transfer system comprising a host controller and a master device, the method comprising:
generating a periodical signal in the host controller according to a host clock in the host controller;
adjusting a local audio clock of the master device according to the periodical signal,
adjusting a local video clock of the master device according to the periodical signal;
capturing audio data by the master device according to the adjusted audio clock, and
capturing video data by the master device according to the adjusted video clock; and
transferring the audio data and video data from the master device to the host controller.

9. The method according to claim 8, wherein before adjusting the local audio clock of the master device according to the periodical signal, and adjusting the local video clock of the master device according to the periodical signal, the following process is performed:
determining if the periodical signal is lost, if yes, patching one periodical signal.

10. The method according to claim 8, wherein the periodical signal is a start of frame signal.

11. The method according to claim 8, wherein the frequency of the periodical signal is 8 KHz or 1 KHz.
